(19) United States
(12) Patent Application Publication
(10) Pub. No.: US 2026/0342541 A1
(43) Pub. Date: Oct. 29, 2026

(54) COMPUTER IMPLEMENTED METHODS AND SYSTEMS FOR PUBLIC KEY INFRASTRUCTURE AND IDENTITY VERIFICATION

(71) Applicant: nChain Licensing AG, Zug (CH)

(72) Inventor: Craig Steven WRIGHT, London (GB)

(21) Appl. No.: 19/134,655

(22) PCT Filed: Nov. 17, 2023
(86) PCT No.: PCT/EP2023/082204

§ 371 Date: May 30, 2025

(30) Foreign Application Priority Data
Dec. 1, 2022 (GB) 2218063.2

(51) Int. Cl. H04L 9/08; H04L 9/00; H04L 9/32

(52) U.S. Cl. CPC H04L 9/0825; H04L 9/321; H04L 9/50

(57) ABSTRACT

Embodiments provide secure and flexible technical solutions for the verification of a user's identity, the creation of a web of trust, and/or the implementation of a PKI or Web of Trust. Some embodiments may be particularly suited for use in conjunction with a blockchain. The disclosure enables a validating entity to apply their own rules, policies and criteria for selection and/or combination of identity resources e.g. documents from a set of such resources that have been made available by a user. Thus, the user has control over which documents are made available to the validating entity, while the validating entity is able to select which, how many, and what type of resources it deems acceptable in order to successfully establish the user's identity. Access to a resource controlled by the validating entity is granted or denied as a result of the attempt to validate that the user is who they say they are based upon the resources they have provided.

### CROSS REFERENCE TO RELATED APPLICATIONS

This application is the U.S. National Stage of International Application No. PCT/EP2023/082204 filed on Nov. 17, 2023, which claims the benefit of United Kingdom Patent Application No. 2218063.2 filed on Dec. 1, 2022, the contents of which are all incorporated herein by reference in their entireties.

### TECHNICAL FIELD

The present disclosure relates to secure and flexible technical solutions for the verification and validation of identity, the creation or improvement of a web of trust, and/or the implementation of a PKI (public key infrastructure). Some embodiments may be particularly suited for use in conjunction with a blockchain.

### BACKGROUND

There are many situations in which entities (e.g. natural persons and individuals, businesses or computer-based systems) need to prove to another party that they are who they say they are. Therefore, proof and validation of identity are common and routine activities in today's world. For the ease of reference we will use the term “user” to mean an entity which wishes to prove their identity to another (validating) party.

One approach to confirming identity is to use a Public Key Infrastructure (PKI), which involves proving ownership of a private cryptographic key in a way that only the legitimate, bone fide entity would be able to. For example, the private key could be used to encrypt a puzzle that the validating entity can then decrypt with the corresponding public key, or digitally sign a resource such that the validator can check the signature. In this way, PKI provides a ‘trust service’ which can be used to verify that a sender or receiver of data is who they claim to be.

However, different validating entities can require different types of proof. For example, one organisation may require a utility bill and a driving licence as proof of an individual's identity, while another might require a passport, a university degree certificate and a bank statement. Collating and providing various combinations of proofs can be challenging for the entity that is attempting to prove their identity. Moreover, documents and other proofs can expire or become obsolete and thus may need to be revoked or disregarded as a legitimate source of identification. From the perspective of the validating entity, there is a need to specify, obtain and check one or more proofs which it deems as sufficient to establish identity. Known approaches to this validation process can be time and energy consuming. Therefore, it would be advantages to provide a solution which enables entities to prove and validate identity in a secure, efficient and flexible manner. A solution has now been devised which addresses at least these technical challenges and provides at least these technical effects.

### SUMMARY

Embodiments of the disclosure aim, at least, to provide a general purpose identity solution that enables an entity (e.g. an individual or group of natural persons, a legal entity, an organisation or one or more computer-based resources etc) that we will call a “user” to prove their identity to another party that we will call the “validating entity” for ease of reference. In some embodiments, this can be achieved or at least facilitated via the use of a blockchain.

In some embodiments, the solution incorporates aspects of on-chain PKI but, importantly, in accordance with disclosed embodiments the user can determine and/or create a set of rules and policies concerning the identity-related resources (e.g. documents) that it wishes to make available to one or more validating entities for the purpose of proving their identity. Additionally, or alternatively, the validating entity is able to apply its own set of rules and policies when selecting identity-related resources during an attempt to verify the user's identity.

The validating entity can be any type of entity that wishes to confirm the identity of the user (e.g. an individual or group of natural persons, a legal entity, an organisation or one or more computer-based resources etc). In a preferred embodiment, the at least one validating entity is able to select one or more identity resources from a plurality of such resources that the user has made available to them. This distinguishes the present invention over prior art arrangements in which the user chooses which identity resources it will provide to the validating party, and also prior art arrangements where the validating party sends a request for specific types of identity resources. This enables the validating entity to apply their own rules, policies and/or criteria to the selection of identity resources that they require for validation purposes. For example, one validating entity may select a utility bill and driving licence as sufficient proof of identity, while another validating entity may select a passport, birth certificate and social security number in accordance with the validating entity's pre-determined criteria.

In certain embodiments, the validating entity may rank (i.e. weight) the identity resources and/or assign a pre-determined value to the resource type. For example, a validator may utilise a points-based approach in which different identity resources are assigned different points or weights according to their perceived significance or trustworthiness as evidence of identity, and a predetermined number of points may be chosen as the threshold for establishing identity. The type and/or number of identity resources selected by the validating entity may then be dependent upon the identity resources made available by the user and required by the validator. For example, a validating entity may determine that a minimum of 50 points is required to validate a user's identity, and that a utility bill counts for 25 points and a driver's license for 30 points. If the user has made their utility bill and driving license available, selection of these two identity resources by the validating entity will be considered sufficient by the validating entity to establish that the user is who they say they are. On the other hand, another validating entity e.g. a potential employer may determine that a University degree certificate is a required identity resource along with any one of a passport, birth certificate or driving license.

Therefore, embodiments facilitate on-chain PKI beyond a simple “I have a cryptographic key that I can use to sign something with”. The disclosure enables the construction of different levels of trust and security using a more granular yet flexible approach, by allowing validating third parties to choose from a plurality of identity resources provided by the user.

In this way, embodiments of the disclosure enable the creation of a web of trust or PKI based upon the provision and use of different attestation sources.

It should be noted for the sake of clarity that the term “validation” is used in this context in the conventional sense of the term and with respect to the establishment of a user's identity rather than the validation functionality performed by nodes on a blockchain network.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 is a block diagram showing high-level blocks of interacting functional blocks according to a preferred embodiment,

FIG. 6 is a block diagram showing a plurality of members of a set of digital identity resources and connections between such members, and

FIG. 7 is a flow chart showing steps which are carried out in accordance with a preferred embodiment.

### DETAILED DESCRIPTION OF EMBODIMENTS

We now provide, for the purpose of illustration, some examples of systems and methods that can be used to implement preferred embodiments of the disclosure.

In accordance with an illustrative embodiment of the disclosure, consider a scenario in which an entity such as, by way of example only, a user wishes to provide evidence to at least one third party so that the third party can validate the user's identity and the user can prove that they are who they say they are.

In the example below, we use a scenario in which a user wishes to prove their identity in order to open a bank account. It should be noted that this is for illustrative purposes only, and the user's identity may be validated in respect of any purpose. Typically, however, identity validation will be performed prior to performing an authorised action, gaining access to some controlled resource (whether that is a physical, electronic resource such as a vehicle, building, network account, piece of software etc etc), or the performance of a controlled service. In our simple example, the controlled service is the provision of a financial account, but any other controlled resource could be substituted for this example.

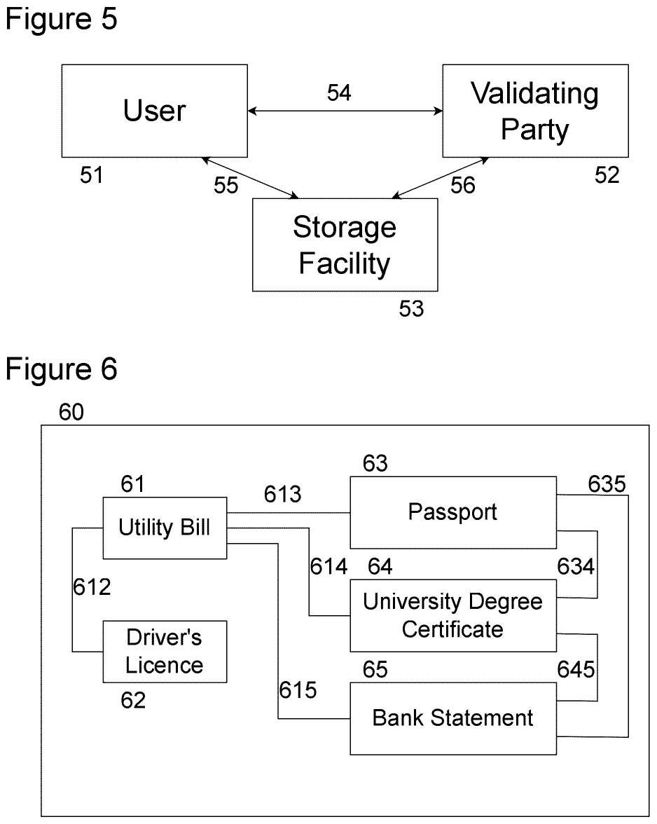

As shown in FIG. 5, example user 51 is a user who wishes to open up a bank account, for example, at a bank 52. Bank 52 is the validating party, and bank 52 requires the user 51 to prove the user 51's identity to the bank 52 before the bank 52 will allow the user to open a bank account at the bank 52. This is because the bank 52 needs to know exactly which party it is opening the bank account for, in the event, for example, that user 51 is acting fraudulently and presents a different name to the bank than the user 51's real name while attempting to open the bank account.

In FIG. 5, according to the example being described, the bank 52 requires the user 51 to provide a certain set of official documents to the bank in order for the user 51 to adequately prove user 51's identity to the bank 52. User 51 provides a set of official identity proving resources (e.g. documents) to a storage facility 53, over a network connection (which could be an Internet connection or a mobile phone connection or other well-known network connection for allowing data to be exchanged). The set of official identity providing documents could be, for example, a driver's license in the name of user 51, a birth certificate in the name of user 51, a passport in the name of user 51, a social security card in the name of user 51, a bank statement associated with another bank account belonging to user 51, a university degree certificate asserting that user 51 has graduated from a specified university and has achieved a certain degree qualification in a specified subject from the specified university. The user 51 stores onto storage facility 53, digital versions of such documents which may have existed originally in paper form, or which have always been embodied in digital form.

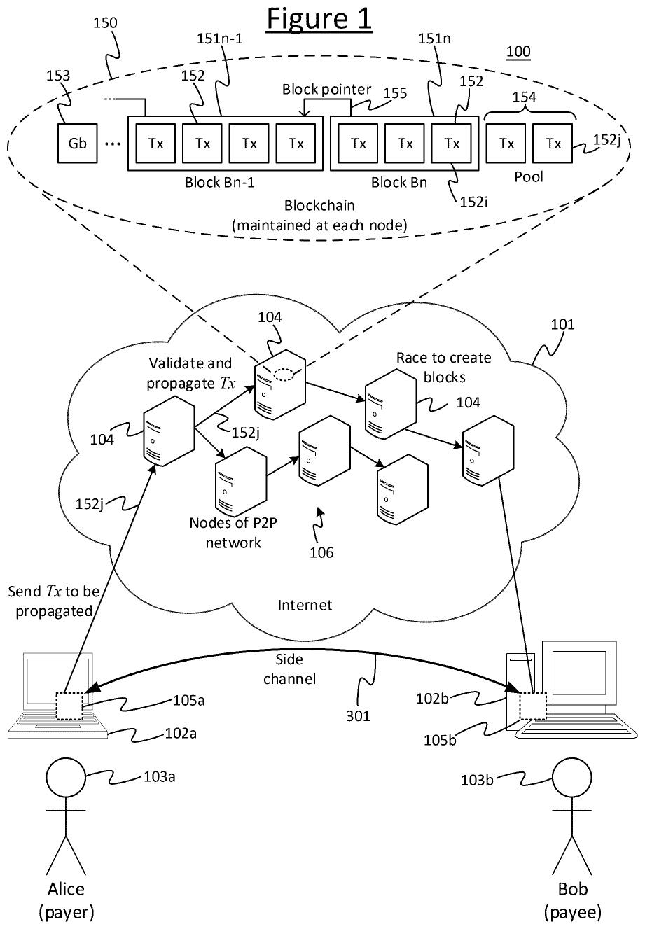

In FIG. 5, the storage facility 53 can be a database, a cloud-based service (of which there are many such services available), or the storage facility could be implemented as a blockchain (details of a blockchain are provided herein in conjunction with FIGS. 1-4) whereas the identity providing resources could be stored on the multiple nodes 104 of a blockchain peer-to-peer network 106 (as shown in FIG. 1).

The user 51 wishes to make certain identity resource(s) available to the validating third party 52, so the user 51 generates a set of at least one (but preferably multiple) identity resources, with examples as given above (driver's license etc). Each identity resource is a resource or item which is associated with the user in some way. In one or more embodiments, the identity resource(s) are selected, possibly by the user, from a plurality of resources that the user has ownership and/or control of.

An identity resource can take any suitable form of identity evidence. Preferably, it is an electronic resource comprising data in a digital form. For example, it could be an electronic document such as a scan, photograph, PDF or other electronic capture of a paper-based document. Alternatively, it could be or comprise a software generated data such as a digitally signed resource etc. The identity resource may be issued or provided by any suitable issuing source such as, for example, a utility provider, a passport office, a licensing authority, a public notary or a bank etc.

Upon selecting the set of identity resources that the user wishes to provide for verification, the user makes them available to the at least one third party. This can be achieved in any manner as appropriate for a particular implementation. Preferably, the identity resources are provided by the user for storage in a storage facility 53. This could comprise a database, a blockchain, a cloud-based resource etc, as mentioned above. The nature or form of the storage facility is not limited. For example, in one implementation the user may make the identity resources available via a web site, while in another they may upload them to a document resource such as Microsoft SharePoint. The user may share a URL or a link to the location of the identity resources with the at least one third party.

In a preferred embodiment, the identity resources are managed on the storage facility 53 by a digital wallet. The digital wallet may be used and accessed by the user 51 via an interface or software application (app). In some embodiments, one or more of the identity resources are stored in the user's wallet but are registered on a blockchain. This provides the advantage that their registration can be verified in an immutable and timestamped manner, and the wallet can revoke a particular identity resource e.g. if it has expired or become outdated, or if the user no longer wishes to provide it as evidence of identity. This can be achieved by implementing the storage facility 53 on the multiple nodes 104 of a peer-to-peer blockchain network 106, all illustratively shown in FIG. 1. The digital wallet application can be run on top of the software layer which implements the blockchain peer-to-peer functionality. For example, the digital wallet application can be constructed as a smart contract, containing business logic code for implementing the wallet functionality, or the wallet may comprise the smart contract(s)

In this embodiment, the set of identity resources associated with the user 51 can be stored in blocks Bn−1, Bn, etc . of a blockchain 150 running on node 104 of the blockchain peer-to-peer network 106 of FIG. 1. When the user 51 decides to add new identity resources to the blockchain, or to remove certain identify resources from the blockchain, such as where such an identity is outdated or expired, these identity resources can be added to the mempool 154, waiting to be incorporated the blockchain's blocks 152. This can be accomplished by generating transactions comprising these identity resources (or references to them) and then submitting the transaction(s) to the mempool for subsequent inclusion on the ledger.

In FIG. 5, the user 51 can be thought of as Alice (the payer 103a) of FIG. 1 and likewise the validating party 52 of FIG. 5 can be thought of as Bob (the payee 103b) in FIG. 1.

As is known, the data stored in the blockchain 150 is immutable, meaning that no other user can change the data without this change being immediately clear to all other users of the blockchain. This is achieved by the use of cryptographic primitives such as a hash function, digital signature and encryption. Accordingly, the set of identity resources that user 51/103a adds to the blockchain 150 is securely registered in the storage facility 53/blockchain 150. Due to the properties of the hash function (result is deterministic and cannot be reversed) it could be easily verified if the content of the block was modified by hashing the block content again and comparing it with the identifier from the subsequent block, as is known in blockchain technologies.

Preferably, access to the storage facility 53 and/or identity resources stored in the storage facility 53 is controlled so that only authorised third parties (such as validating party 52) are able to gain access to the identity data. The user 51 may share, via any suitable means, an access control mechanism with the at least one third party (e. g, validating party 52) so that the at least one third party can access the identity resources at the storage facility. The user 51 may wish to allow a plurality of third parties to have access to the user 51's set of identity resources, and the user 51 would then share the access control specifics with each of such third parties. For example, the user 51 may want to allow other third parties, in addition to the bank 52 to obtain access to the set of identity resources such as a law firm (who would be conducting, for example, a money laundering check on the user 51 in advance of taking on the user 51 as a new client).

In FIG. 5, the user 51 can communicate such access control specifics directly to the validating party 52 via the direct connection 54 (over a network as discussed above), or via the storage facility 53 as an intermediary, over connection 55 between the user 51 and the storage facility 53 and then over connection 56 between the storage facility 53 and the validating party 52.

While only one user 51 and one validating party 52 is shown in FIG. 5, a plurality of users 51 and a plurality of validating parties 52 would typically be included, in a usual implementation of the disclosed technology.

The access control mechanism can be any suitable authorisation means such as a secret identifier e.g. a password, PIN or a cryptographic key etc . The access control mechanism may be arranged to allow temporary access only. For example, it may expire or cease to be operational upon fulfilment of a criteria set by the user. For example, it may expire after a certain period of time has elapsed, or when a certain date or time is reached, or after it has been used to gain access for a pre-determined number of times.

In a preferred embodiment, each third party (e.g. the bank 52 in the example above and any other third party, such as the law firm mentioned above) is given their own, respective access control mechanism. The identity resources may be organised or structured in some way by the user so that different types of identity resources can be made available to different third parties. For example, the identity resources may be arranged in a hierarchical structure according to the degree of confidentiality determined by the user to apply to a particular resource. For example, the user may consider that utility bills and birth certificates are less confidential than passport details which, in turn, may be deemed less confidential than a social security number, bank account details or tax identification number. A third party that needs to validate the user's identity may be provided with an access control mechanism which allows it to access resources in one or more levels of the data structure. Thus, access permissions can be provided to allow varying degrees of access as determined necessary or appropriate by the user. This may comprise an assessment of trust made by the user in respect of a given third party. For example, a user may consider that a government department such as a tax or passport office is more trustworthy than a credit provider for a loan to purchase a car.

Each user 51 can apply its own set of rules or policies to its corresponding set of identity resources which are being stored in the storage facility 53. For example, a user 51 can specify a policy where only certain very trusted third parties 52, such as government entities, can access the digital representation of the birth certificate of the user 51, whereas a wider range of third parties 52 can access other members of the set of identity resources, such as the pdf scan copy of the passport of user 51 or driver's license scan of user 51. This policy could be specified by sharing a different access control mechanism for different validating third parties 52, as mentioned above, or, alternatively, the user 51 could specify a policy for sharing certain members of the set of identity resources which could be coded as part of a smart contract, where the storage facility 53 is implemented as a blockchain as discussed above. Any other way of coding a policy could also be used to specify the user 51's particular circumstances and desires regarding the sharing of the identity resources.

Likewise, each validating party 52 can specify its own set of rules or policies which can be applied to the set of identity resources which at least one user 51 has stored on the storage facility 53 and shared with each such validating party 52. For example, one validating party 52 may require a review of a utility bill (e.g., a water bill, an energy bill etc.), as well as a driver's license, and if those two identity resources are accessed by the validating party 52, then the validating party 52 considers this to be sufficient to verify the identity of user 51. On the other hand, another validating party 52 may require a passport scan, a university degree certificate and a bank statement. Yet another validating party 52 may require all of the just mentioned identity resources to be checked. Each such validating party 52 can apply its own set of rules or policies to select the specific members of the set of identity resources that the user 51 has stored on the storage facility 53. This set of policies/rules could be specified by coding the set of policies/rules as part of a smart contract, where the storage facility 53 is implemented as a blockchain as discussed above. Any other way of coding a policy could also be used to specify the user 51's particular circumstances and desires regarding the sharing of the identity resources.

The sets of policies/rules discussed above, which are set by the user 51 and by the validating party 52, could be implemented in software logic by assigning connections between each member of the set of identity resources, and then, each of those connections can be assigned a weighting or ranking depending on the level of importance that the user 51 or the validating entity 52 assigns to that pairing of members of the set of identity resources.

Specifically, a set 60 of identity resources is shown in FIG. 6 for a particular user 51, which the user 51 has decided to share with validating entities (such as validating entity 52) and store into the storage facility 53. In FIG. 6, in the illustrate example, the set of identity resources 60 includes a utility bill 61, a driver's license 62, a passport 63, a university degree certificate 64 and a bank statement 65. In a preferred embodiment, one or more of the identity resources may be cryptographically secured, generated, signed or encoded by an issuing entity. For example, the issuing entity for a passport would typically be a government passport office, and an issuing entity for an academic certificate might be a University. The use of cryptography enables the identity of the issuing entity (and thus the authenticity of the identity resource) to be verified. For example, the issuing entity may use a private key to encode or sign the identity resource or a certificate associated with it. A public key associated with the private key can be used to decode the resource or certificate, or check the signature. In this way, the validity of the identity resource(s) can be attested to by the use of cryptographic keys. The association of a public key with a particular issuer may be obtained from a Web of Trust. Additionally, or alternatively, a public key may be obtained directly from an issuer or known representative. In this way, a validating entity can check that an identity resource provided by a user is genuine and has not been faked, counterfeited or altered from its original issued state This provides an improved level of security for the validating entity.

A connection 612 between the utility bill 61 and driver's license 62 is shown in FIG. 6. Likewise, a connection 613 is shown between the utility bill 61 and passport 63, a connection 614 is shown between the utility bill 61 and the university degree certificate 64, a connection 615 is shown between the utility bill 61 and the bank statement 65, a connection 634 is shown between the passport 63 and the university degree certificate 64, a connection 635 is shown between the passport and the bank statement and a connection 645 is shown between the university degree certificate 64 and the bank statement 65.

Each of these connections 612 through 645 can have weightings (which may be referred to as “points” or “values”) assigned to them so that the particular pairing of identity resources can be ranked according to how important that particular pairing is to a policy that has been set by either the user 51 and/or the validating party 52. Alternatively, instead of the connection between members of the set of identity resources being weighted, each member itself (61 to 65) of the set 60 can be assigned a weighting. The validator's rules may specify that the combination of identity resources may need to reach a sufficient number of total “points” in order for the user's identity to have been deemed successfully verified.

Where the connections are weighted, for a particular policy that a particular validating party 52 wishes to implement, where the validating party 52 requires to access the utility bill 61 and the driver's license 62, the connection 612 can be given a very high weighting, such as 95 (where it is assumed that the rankings range from 0 to 100). Likewise, for another validating party 52 which requires to access the passport 63, the university degree certificate 64 and the bank statement 65, the connections 635, 634 and 645 can be assigned very high weightings such as 90.

Likewise, the user 51 can assign weights to the members of the set 60 of identity resources, indicating the user 51's preferences/policies/rules regarding sharing of each member of the set with validating entities. For example, if a low weighting is assigned to a particular connection between (i.e. combination of) two members, such as if a 20 weighting is assigned to the connection 612 between the utility bill 61 and the driver's license 62, then the user 51 considers these two members of the identity resource set 60 to be less sensitive and more easily accessible by a wider range of validating parties 52.

In a situation where a user 51 is not aware of the policies of each of the potential validating parties 52 the user 51 may assign a very low weighting to the members (or to connections between each of the members), to make sure that each validating party 52 can apply, to the fullest extent, such validating parties' rules or policies. That is, in a case where a validating party 52 requires to access the passport 63, the driver's license and the university degree certificate 64, the user 51 must have assigned a low enough weighting to each such member (or connection between members) so that each of those three members can be accessed by the validating party 52.

In a Web of Trust implementation, trust relationships are established between users wishing to communicate with each other. Each user decides which other users the user is to trust and by how much. A user signs the public cryptographic key of each other user that the user trusts and also assigns a trust value (a numerical value in a range of say 1 to 255) indicating the extent of the trust. A calculation is made by adding trust values. Likewise, in FIG. 6, each member of the identity resource set 60 can sign an identity key (public cryptographic key) and a trust value can be assigned by the validating party 52 to that member of the identity resource set 60, to thus allow for a calculation of points for a specific grouping of one or more members of the identity resource set 60. For example, a bank 52 can specify that it trusts the driver's licence by 30 points and the passport by 40 points, and the bank 52 can specify a policy where if the point value total passes a certain threshold, then the user 51 is to be considered trustworthy.

Thus, embodiments of the disclosure provide new security and trust solutions for user verification relative to the prior art. With respect to a conventional PKI approach, a centralised (trusted) Certificate Authority is relied upon to issue and sign digital certificates. The CA binds public cryptographic keys with the respective identities of the entities that own (or at least control) those keys. However, dependence upon a trusted CA (whether that be a hierarchy of CAs or a single entity) inherently involves a single point of failure. In contrast to conventional PKI techniques, however, one or more embodiments of the disclosure do not necessitate reliance upon a centralised CA in order for a user to prove their identity to a validating entity.

In an alternative approach to PKI, a conventional, decentralised Web of Trust (WoT) model attempts to address this centralised reliance. Instead, in the WoT a level of trust is determined and assigned to a particular entity via the binding/association of a key to that entity by other users within the web. As explained at/w Web of trust:
“OpenPGP-compliant implementations also include a vote counting scheme which can be used to determine which public key—owner association a user will trust while using PGP. For instance, if three partially trusted endorsers have vouched for a certificate (and so its included public key—owner binding), or if one fully trusted endorser has done so, the association between owner and public key in that certificate will be trusted to be correct. The parameters are user-adjustable (e.g., no partials at all, or perhaps six partials) and can be completely bypassed if desired.”

Thus, in the prior art WoT approach, keys are associated with their owning/controlling entity. By contrast, embodiments of the disclosure can enable the construction of a web of trust in which a validating entity assigns levels of trust (e.g. by a points value) to different, specific identity resources rather than to simply to their sources. Embodiments can be used to extend a conventional WoT such that the validating entities within the web can not only apply their own parameters for determining trust of sources, but also the type, nature, and significance of an identity-related resource e.g. document issued by other users. Therefore, embodiments can provide different technical solutions compared to conventional trust models used for identity verification e.g. WoT or PKI.

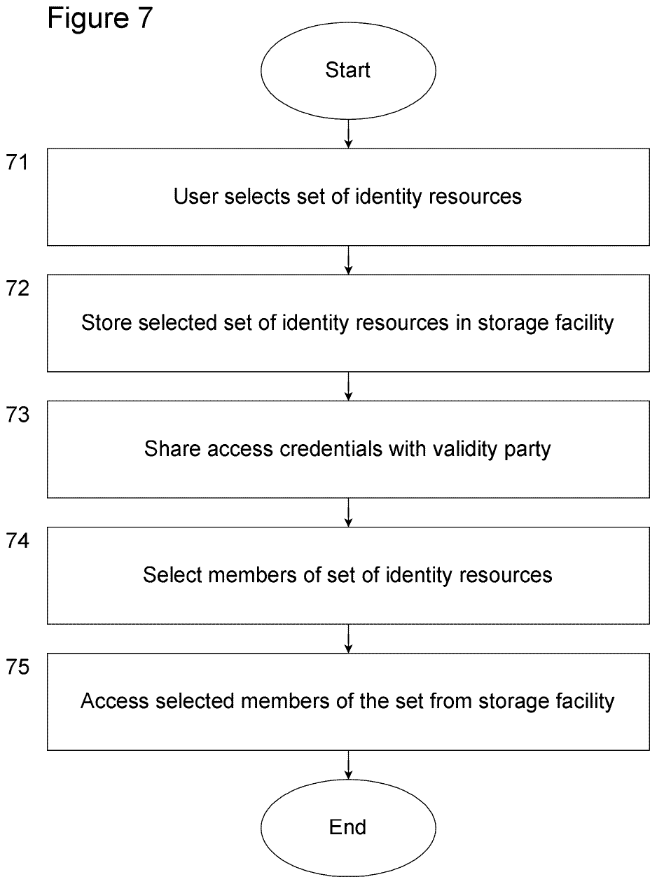

The flow chart of FIG. 7 shows the steps to be carried out by the logic, possibly implemented within the storage facility 53, such as implemented in the business logic of a smart contract running on a blockchain 106.

In FIG. 7, at step 71, the user 51 (FIG. 5) selects a set 60 (FIG. 6) of identity resources 61-65 (FIG. 6) for storing in the storage facility 53. At step 72, the set is stored in the storage facility 53. At step 73, the user 51 shares access credentials with the validating party (or plurality of validating parties). At step 74, the validating party implements a policy or set of rules (e.g., by executing the logic/code to assess the weighting of members of the set of identity resources 60 and/or to connections between such members), to select one or more members of the set of identity resources. At step 75, the validating party accesses the selected members of the set of identity resources from the storage facility 53. Once the validating party 52 accesses the selected members of the identity resources of the set from the storage, the validating party 52 can then review them, either manually or by computer automation, to determine whether the validating party is satisfied that the user 51 is who the user 51 purports to be.

As an example, the bank environment mentioned above will be discussed. The user 51 wishes to open a bank account with the bank 52. The user 51 selects a set of identity resources, including the utility bill 61, driver's license 62, passport 63, university degree certificate 64 and bank statement 65, and stores this selected set of identity resources into the storage facility 53 (steps 71 and 72 of FIG. 7). This can be done, for example, by storing data into a blockchain, as discussed above.

The user 51 then shares access credentials with the bank 52 (step 73). The bank 52 then applies a policy or set of rules (step 74) by assessing, for example, the weightings of the members of the set 60 (or the weightings of the connections between the members of the set 60) to select the members of the set for review. For example, the bank may have a high weighting (of 85) for the passport 63 and a high weighting of 90 for the bank statement 65, thus signifying to the coding logic (e.g., smart contract) that these two members of the set 60 are required to be reviewed by the bank 52. The bank 52 then accesses the selected members of the set (the passport 63 and bank statement 65) from the storage facility 53 and reviews them, in order to determine whether the bank 52 is satisfied that the user 51 is who the user 51 purports to be.

### Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

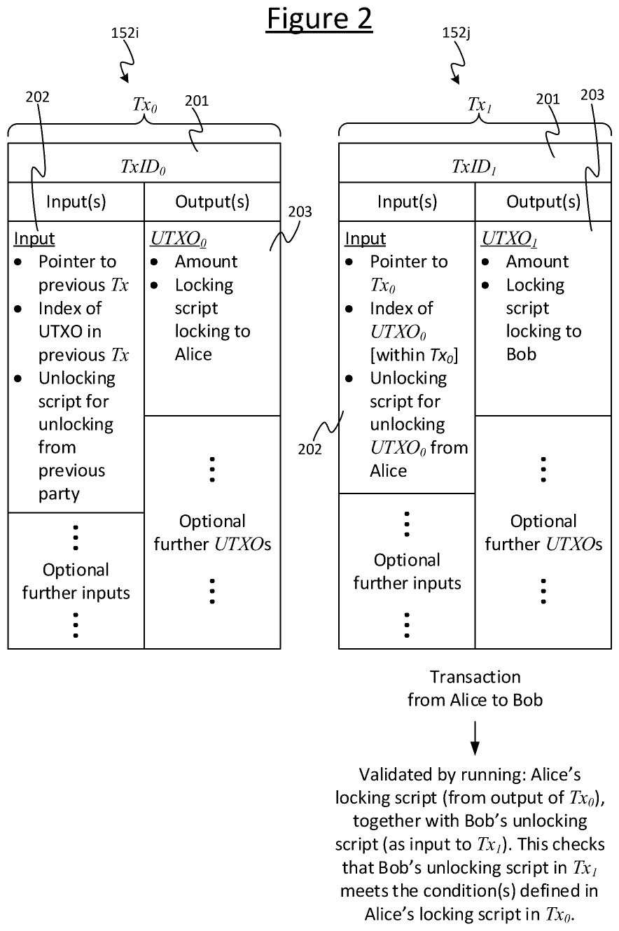

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx1 further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically, an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 5. Client Software

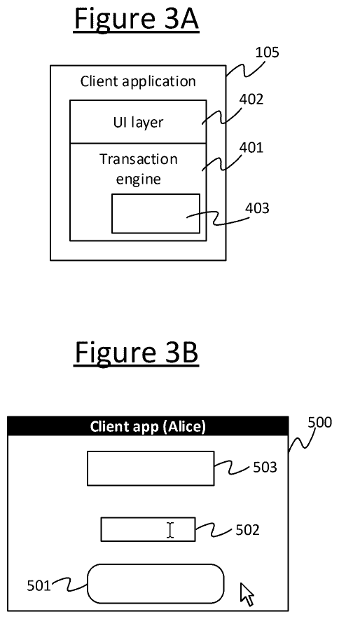

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the Ul layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively, or additionally, the UI elements may comprise one or more data entry fields 502. These data entry fields are rendered via the user output means, e.g. on-screen, and the data can be entered into the fields through the user input means, e.g. a keyboard or touchscreen. Alternatively, the data could be received orally for example based on speech recognition.

Alternatively, or additionally, the UI elements may comprise one or more information elements 503 output to output information to the user. E.g. this/these could be rendered on screen or audibly. It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 6. Node Software

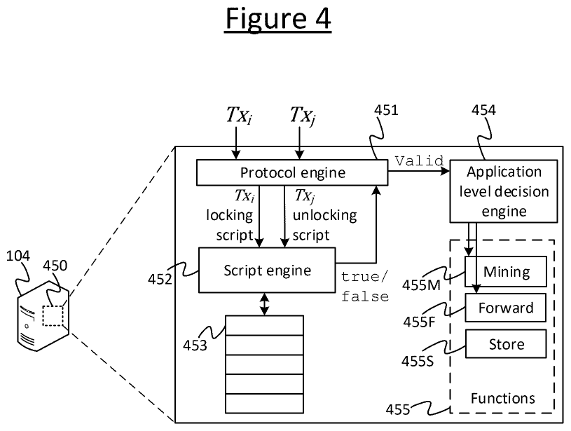

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains one or more of: a consensus module 455C (for example, proof-of-work), a propagation module 455P and a storage module 455S (for example, a database). The consensus module 455C may contain a validation module (not shown) configured to validate transactions according to the blockchain protocol. The validation module may instead be separate from the consensus module 455C. One or more of the modules may operate in parallel. A node 104 may contain additional modules. The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e., does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise, it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g., the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance, in an account-based model, a result of “true” could be indicated by a combination of an implicit, protocol-level validation of a signature and an additional affirmative output of a smart contract (the overall result being deemed to signal true if both individual outcomes are true).

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

### Enumerated Statements

It will be appreciated that the above embodiments have been described by way of example only.

More generally there may be provided method(s), apparatus or program(s) in accordance with any one or more of the following Statements. Any feature(s) provided below in respect of one statement set is not limited as such, and may be incorporated into one or more other statement sets.

In accordance with one form of wording, embodiments of the disclosure may provide methods and/or systems for validation of a user's identity, establishment of a user's identity, controlling access to a controlled resource such as a service and/or physical/electronic resource. Additionally, or alternatively, embodiments of the disclosure may be described as providing a security method/system/apparatus, preferably for securing access to a controlled resource such as a service or physical/electronic resource. Additionally, or alternatively, embodiments may be described as facilitating an improved Web of Trust (WoT) solution (methods, systems or apparatus). an additional, or alternative form of wording, the disclosure may provide: a computer-implemented verification method for verifying the identity of a user, the method comprising the steps:
selecting, or attempting to select, by a validating entity, at least one identity resource from a set of identity resources made available to the validating entity by the user for verifying the user's identity;
wherein the selection or attempt to select at least one identity resource from the set of identity resources is performed in accordance with at least one rule or selection criterium established by the validating entity.
In some or more embodiments, one or a plurality of identity resources in the set of identity resources may be assigned, by the validating entity and/or in accordance with the at least one rule or selection criterium, a respective weighting. In other words, the identity resource, or each of the identity resources in a plauraltiy of identity resources, may be assigned a weighting or value. This may be assigned by the validating entity.
Additionally or alternatively, a connection, association or combination of at least two of identity resources in the set of identity resources may be assigned a weighting.

The weighting(s) may be used, by the validating entity, to establish the identity of the user. This may involve (comprise) assessing the weighting or combined weightings against a threshold value that is pre-determined by the validating entity. If the weighting or combined weightings of the user's identity resource(s) meet or exceed the threshold, the user's identity may be deemed to be validated, or not validated if the threshold is not met.

### Statement Set 1

In accordance with one possible wording, an embodiment of the disclosure may provide:
1. A computer-implemented method comprising the steps:
   attempting to select, by a validating entity, at least one identity resource from a set of identity resources made available to the validating entity by a user for verifying the user's identity.
   The attempt to select at least one identity resource from the set of identity resources may, preferably, be performed in accordance with at least one (software automated/enforced) rule or selection criterium established by the validating entity.

The validating entity may be the owner, controller and/or provider of a controlled resource. Successful verification of the user's identity may be required by the validating entity prior to allowing access to the controlled resource by the user. The validating entity may generate or use at least one rules, policy and/or criterium for establishing successful verification of a user's identity.

The at least one rule, policy and/or criterium may specify which, how many and/or what type of identity resource(s) are required for successful identity verification of a (or the) user, or any other criteria relating to identity resources which the validating entity determines to be relevant for verification purposes. Additionally, or alternatively, the at least one rules, policy and/or criterium may specify which identity resources may be combined to meet the validating entity's requirements for successful identity verification. In order to facilitate this, different types, formats or other parameters relating to identity resources may be assigned respective weightings or values or “points”. The at least one rule, policy and/or criterium may specify a threshold value or number of points which must be reached by selecting one or a combination of identity resources from the set of identity resources in order for identity validation to be successful. The at least one rule, policy and/or criterium may specify a minimum or maximum number of identity resources which may be combined to reach the threshold value. If the validating entity is not able to select the required number, type or other form of identity resources to reach threshold value from the set of identity resources, the attempt to verify the user's identity will be rejected and deemed to fail.

The set of identity resources may be selected and/or generated by the user. The set of identity resources may be made available to the validating entity by the user by providing the set of identity resources in or on a storage facility. The storage facility may be a blockchain. The set of identity resources may be managed by a digital wallet. When we say that an action is performed “by the user” this may mean that the user themself performs the action e.g. via an interface to a software component or system, or that the action is performed automatically by a software system/component that is own/controlled/operated by the user and the action is performed on the user's behalf via the system/component.

The user and/or validating entity may be an actor or participant in a Web of Trust and/or Public Key Infrastructure (PKI) arrangement/implementation/system.

The set of identity resources may be made available to the validating entity by the user by sharing access credentials, by the user to the validating entity.

The access credentials:
i) may comprise one or more of: a password, PIN, passcode or other identifier; or a cryptographic key; and/or
ii) may be generated by the user; and/or
iii) may be associated with or assigned to the validating entity by the user.

The set of identity resources may be made available to the validating entity by the user by using a blockchain. The set of identity resources may be included or referenced from a transaction on the blockchain. The at least one rule or selection criterium may be implemented in a smart contract arranged for execution on and/or interaction with a blockchain.

The at least one rule or selection criterium may be implemented in software logic.

In some embodiments, one or a plurality of identity resources in the set of identity resources may be assigned a respective weighting. The weighting may alternatively be referred to as a value or number of points. The weighting for a given identity resource may be determined by the validating entity. Additionally, or alternatively, it may be determined in accordance with the at least one rule or selection criterium, and/or implemented as part of the software logic for the at least one rule or selection criterium. The connection, association or combination of at least two identity resources in the set of identity resources may be assigned a weighting, value or number of “points”. The weighting may be used to determine the at least one identity resource in the set of identity resources is to be selected in accordance with at least one rule or selection criterium.

Verification of the user's identity may be rejected by the validating entity if, in accordance with the at least one rule or selection criterium, no identity resources can be selected from the set of identity resources. The method may comprise the step of: using the at least one identity resource selected from the set of identity resources to attempt to verify the user's identity.

At least one of the identity resources in the set of identity resources may be signed, encoded, secured or otherwise associated with a cryptographic key. The cryptographic key may be owned by, controlled by or associated with an issuing entity of the at least one identity resource. The cryptographic key may be part of a key-pair. It may be a private key. The validating entity may use a corresponding cryptographic key (e.g. a public key corresponding to the private cryptographic key) to validate/check that the at least one identity resource has been validly issued by the (authorised, legitimate) issuing entity. The issuing entity, the validating entity and/or the user may be an actor or participant in a Web of Trust or PKI.

The method may comprise the step of: denying access to a controlled resource if verification of the user's identity is rejected; or allowing access to a controlled resource if verification of the user's identity is successful.

The set of identity resources may be selected and/or generated by the user as a subset of a larger set of identity resources. This may be performed in accordance with at least one (automated) rule, policy or criterium applied by the user or a software component controlled/owned/operated by the user. For example, the suer may determine that a document comprising the user's social security number may only be provided to validating entities that are government agencies; or that academic degree certificates may only be made available to academic institutions or potential employers for their identity validation purposes. Additionally, or alternatively, the user may specific on an ad-hoc basis which particular validating entities may have access to one, some or all of the user's set of identity resources. This selection of the set of identity resources may be specified by the user themself via an interface to the user's software component e.g. digital wallet.

The method may comprise the step of: removing, by the user, at least one identity resource from the set of identity resources. The user may remove one or more resources from the set based upon a variety of criteria e.g. date, privacy concerns etc. Thus, the user may revoke an identity resource.

There may also be provided: computer equipment comprising:
memory comprising one or more memory units; and
processing apparatus comprising one or more processing units, wherein the memory stores code arranged to run on the processing apparatus, the code being configured so as when on the processing apparatus to perform the method of any embodiment claimed or disclosed herein.

There may also be provided: a computer program embodied on computer-readable storage and configured so as, when run on one or more processors, to perform the method of any embodiment claimed or disclosed herein.

### Statement Set 2

In accordance with an alternative wording, there may be provided:
a computer-implemented method comprising the step of receiving from a user, a set of identity resources for proving or establishing the identity of the user to a validating entity.

The terms “proving” and/or “verifying” may be used instead of “establishing”. the set of identity resources may comprise one or more identity resources. Therefore, in some embodiments, the set of identity resources may comprise a plurality of identity resources while in other embodiments, the set of identity resources may comprise only one.

The method may comprise the step of providing one or more of the set of identity resources in a storage facility. The terms “registering”, “uploading” and/or “storing” could be used instead of “providing”.

The method may comprise the step of identifying and/or selecting at least one of the set of identity resources in accordance with a selection criteria established by the validating party. The terms “determined”, “selected” and/or “specified” could be used instead of “established”.

The method may comprise the step of providing access to the selected at least one of the set of identity resources to the validating entity by sharing access credentials with the validating entity.

The storage facility may comprise a blockchain. The set of identity resources provided in the storage facility may be managed by a software resource such as, for example, a digital wallet. The access credentials may be specific to the validating entity. In other words, the access credentials may be associated (by the user) with only the validating entity.

The method may comprise one or more steps in which a set of rules or policies is received from a validating entity. The set of rules may be arranged to allow or enable selection of one or more of the identity resources in the set of identity resources. In embodiments where the storage facility is a blockchain, the set of rules or policies may be implemented in or using a smart contract arranged for execution on or in associated with the blockchain.

The set of rules or policies may be implemented in software logic, preferably wherein each connection between two of the identity resources in the set of identity resources is assigned a weighting and such weighting is used to determine which of the identity resources in the set of identity resources to select.

The set of rules or policies may be implemented in software logic where each of the identity resources in the set of identity resources is assigned a weighting and such weighting is used to determine which of the identity resources in the set of identity resources to select.

### Statement Set 3

In accordance with an additional or alternative wording, there may be provided:
a computer-implemented method comprising the steps:
   generating and/or selecting a set of identity resources; and/or
   providing one, some or all of the set of identity resources on or in a storage facility.

In some embodiments the storage facility may be a blockchain.

The method may further comprise the step of providing access to at least part of the set of identity resources to a validating entity.

The set of identity resources may be generated or selected by the user.

The method may further comprise the step of determining at least one rule or criterium for validating/verifying the identity of a user. The at least one rule or criterium may relate to or be applied to (by the validating entity) one or more identity resources provided by the user. The method may comprise the step of selecting, or attempting to select, in accordance with the at least one rule or criterium, one or more identity resources from the set of identity resources provided by the user. At least one of the identity resources may be registered on a blockchain or other storage facility. At least one of the identity resources may be provided within or referenced from/by a transaction on the blockchain.

### Statement Set 4

In accordance with an alternative wording, there may be provided:
a computer-implemented method comprising the step of providing or using a Web of Trust.

A user and/or validating entity as described above may be a user or participant in the Web of Trust. The method may further comprise one or more features described in respect of any one or more of statement sets 1 to 3.

The method may further comprise:
i) attempting to select, by a validating entity, at least one identity resource from a set of identity resources made available to the validating entity by a user for verifying the user's identity; and/or
ii) receiving from a user, a set of identity resources for proving or establishing the identity of the user to a validating entity; and/or
   generating and/or selecting a set of identity resources; and/or
   providing one, some or all of the set of identity resources on or in a storage facility;
   preferably, the storage facility may be a blockchain; and/or
iii) providing access to at least part of the set of identity resources to a validating entity;
   preferably wherein the set of identity resources may be generated or selected by the user; and/or
iv) determining at least one rule or criterium for validating/verifying the identity of a user;
   preferably, the at least one rule or criterium may relate to or be applied to (by the validating entity) one or more identity resources provided by the user; and/or
v) selecting, or attempting to select, in accordance with the at least one rule or criterium, one or more identity resources from the set of identity resources provided by the user.

One or more of statement sets 1 to 4 may comprise the step(s) of:
i) using a (private) cryptographic key to sign, encode or secure a given identity resource or a certificate related to the identity resource. This may be performed by or on behalf of an issuing entity that has issued, generated and/or provided the identity resource. The cryptographic key may be a private key which has a corresponding public key; The public-private key pair may be associated with, owned by and/or controlled by or on behalf the issuing entity;
ii) using a (public) cryptographic key to check the signature used to sign a given identity resource, decode an encoded identity resource and/or otherwise verify that a corresponding (private) key has been used to sign, encode or otherwise secure the identity resource.

The public key may be obtained from an issuing entity associated with the identity resource, and/or from a Web of Trust.

According to another aspect disclosed herein, there may be provided a computer program embodied on computer-readable storage and configured so as, when run on one or more processors, to perform the method of any of any embodiment(s) disclosed and/or claimed herein.

According to another aspect disclosed herein, there may be provided a system comprising the computer equipment of memory comprising one or more memory units; and processing apparatus comprising one or more processing units, wherein the memory stores code arranged to run on the processing apparatus, the code being configured so as when on the processing apparatus to perform the method of any embodiment(s) disclosed and/or claimed herein.

1. A computer-implemented verification method for verifying an identity of a user, the method comprising the steps:
selecting, or attempting to select, by a validating entity, at least one identity resource from a set of identity resources made available to the validating entity by the user for verifying the user's identity;
wherein the selection or attempt to select at least one identity resource from the set of identity resources is performed in accordance with at least one rule or selection criterium established by the validating entity; and
i) one or a plurality of identity resources in the set of identity resources is assigned, by the validating entity and/or in accordance with the at least one rule or selection criterium, a respective weighting; and/or
ii) a connection, association of combination of at least two of identity resources in the set of identity resources is assigned a weighting.

2. The method of claim 1, wherein:
the set of identity resources is made available to the validating entity by the user by providing the set of identity resources in or on a storage facility.

3. The method of claim 2, wherein:
i) the storage facility is a blockchain; and/or
ii) the set of identity resources is managed by a digital wallet; and/or
iii) the user and/or validating entity is an actor or participant in a Web of Trust or Public Key Infrastructure.

4. The method of claim 1, wherein:
the set of identity resources is made available to the validating entity by the user by sharing access credentials, by the user to the validating entity;
preferably wherein the access credentials:
i) comprise one or more of: a password, PIN, passcode or other identifier; or a cryptographic key; and/or
ii) are generated by the user; and/or
iii) are associated with or assigned to the validating entity by the user.

5. The method of claim 1, wherein:
i) the set of identity resources is made available to the validating entity by the user by using a blockchain, preferably wherein the set of identity resources is included or referenced from a transaction on the blockchain; and/or ii) and the at least one rule or selection criterium is implemented in a smart contract arranged for execution on and/or interaction with a blockchain.

6. The method of claim 1, wherein:
i) at least one of the identity resources in the set of identity resources is signed, encoded, secured or otherwise associated with a cryptographic key that is owned by, controlled by or associated with an issuing entity of the at least one identity resource; and
ii) the validating entity performs the step of using a corresponding cryptographic key to validate that the at least one identity resource has been validly issued by the issuing entity.

7. The method of claim 1, wherein:
the at least one rule or selection criterium is implemented in software logic, and preferably wherein the weighting is used to determine the at least one identity resource in the set of identity resources that is to be selected in accordance with at least one rule or selection criterium.

8. The method of claim 1, wherein:
verification of the user's identity is rejected by the validating entity if, in accordance with the at least one rule or selection criterium, no identity resources can be selected from the set of identity resources.

9. The method of claim 1, comprising the step of:
using the at least one identity resource selected from the set of identity resources to attempt to verify the user's identity.

10. The method of claim 9, and comprising the step of:
denying access to a controlled resource if verification of the user's identity is rejected; or
allowing access to a controlled resource if verification of the user's identity is successful.

11. The method of claim 1. wherein:
the set of identity resources is selected and/or generated by the user.

12. The method of claim 1, wherein:
the set of identity resources is selected and/or generated by the user as a subset of a larger set of identity resources.

13. The method of claim 1, comprising the step of:
removing, by the user, at least one identity resource from the set of identity resources.

14. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a computer-implemented verification method for verifying an identity of a user, the method comprising the steps:
selecting, or attempting to select, by a validating entity, at least one identity resource from a set of identity resources made available to the validating entity by the user for verifying the user's identity;
wherein the selection or attempt to select at least one identity resource from the set of identity resources is performed in accordance with at least one rule or selection criterium established by the validating entity; and
i) one or a plurality of identity resources in the set of identity resources is assigned, by the validating entity and/or in accordance with the at least one rule or selection criterium, a respective weighting; and/or
ii) a connection, association of combination of at least two of identity resources in the set of identity resources is assigned a weighting.

15. A non-transitory computer-readable medium, comprising a computer program embodied configured so as, when run on one or more processors, the one or more processors perform a computer-implemented verification method for verifying an identity of a user, the method comprising the steps:
selecting, or attempting to select, by a validating entity, at least one identity resource from a set of identity resources made available to the validating entity by the user for verifying the user's identity;
wherein the selection or attempt to select at least one identity resource from the set of identity resources is performed in accordance with at least one rule or selection criterium established by the validating entity; and
i) one or a plurality of identity resources in the set of identity resources is assigned, by the validating entity and/or in accordance with the at least one rule or selection criterium, a respective weighting; and/or
ii) a connection, association of combination of at least two of identity resources in the set of identity resources is assigned a weighting.
